(19) United States
(12) Patent Application Publication
(10) Pub. No.: US 2026/0268280 A1
(43) Pub. Date: Sep. 10, 2026

(54) TRACKING FUNCTION COMPLETION USING TEMPLATES

(71) Applicant: Citibank, N.A., New York, NY (US)

(72) Inventors: Ajith NAIR, Jacksonville, FL (US); Subodh Kumar Sharma, Jersey City, NJ (US)

(73) Assignee: Citibank, N.A., New York, NY (US)

(21) Appl. No.: 19/074,669

(22) Filed: Mar. 10, 2025

(51) Int. Cl. G06Q 10/10; G06Q 10/0631

(52) U.S. Cl. CPC G06Q 10/103; G06Q 10/063114

(57) ABSTRACT

Methods and systems are described herein for tracking function completion using electronic artifacts to address the need for systematic management and utilization of completion data in various job management fields such as software, banking, insurance, etc. A function completion data structure may be generated based on user input. The data structure may include a plurality of electronic artifacts and dependency data indicating relationships between these artifacts. For each electronic artifact, a corresponding set of progress tracking templates may be generated, each indicating the completion of a function associated with the artifact. Progress data for a first electronic artifact may be received and updated. Appropriate progress tracking templates may be selected to be completed by associated operators. Once that completion data is received, artifacts may be updated, and other artifacts may be selected for completion.

### BACKGROUND

Tracking parameters for function completion is a critical yet often overlooked element for various job management and tracking fields (e.g., software, fabrication, banking, research projects). In many instances, once a function is completed, the associated data is frequently not stored or systematically managed so it could be used to see an overall picture of a job. Existing technologies for job tracking generally focus on the immediate completion of functions without emphasizing the long-term storage and utilization of completion data. However, this approach may not be optimal in various situations. For example, completed functions may contain valuable information that could be crucial for future reference, auditing, and optimization of subsequent functions.

### SUMMARY

Accordingly, the lack of systematic tracking of completion data may lead to several issues. For instance, the loss of valuable information may hinder the ability to understand function execution, identify potential improvements, and learn from past experiences. Additionally, the inability to audit and review completed functions may be particularly problematic in regulated industries where compliance and accountability are critical (e.g., banking, accounting, finance). Without proper storage of completion data, conducting thorough audits and ensuring that all tasks were completed according to required standards becomes challenging.

Moreover, the absence of detailed completion data may impede the optimization of future tasks. Analyzing completion data may provide insights into the efficiency and effectiveness of function execution, helping operators identify bottlenecks, inefficiencies, and areas for improvement. However, without systematic tracking of this data, optimizing future functions and improving overall project performance becomes difficult. Furthermore, managing function dependencies in complex jobs is challenging without accurate and detailed completion data. This may lead to delays, mismanagement, and a lack of coordination among team members. Therefore, efficient tracking and management of function completion data is important in many applications related to job management and function tracking.

Therefore, methods and systems are described herein for tracking function completion using electronic artifacts (e.g., digital objects each representing a specific function or milestone within a job), thereby optimizing electronic artifact management and tracking (e.g., tasks, milestones, multidisciplinary projects). For example, a function tracking system may be used to perform the operations described herein and may include a function completion data structure. The function tracking system along with a function completion data structure may be deployed on a device (e.g. laptop, desktop, mobile phone) being used in various artifact environments (e.g., software development, banking applications, research projects) where the function tracking system may require the function completion data structure to manage and track the progress of functions associated with electronic artifacts (e.g., coding tasks, building milestones, research phases, etc.).

As the function tracking system determines that a function associated with an electronic artifact has been completed, the function tracking system may evaluate the current electronic artifact dependencies, including the status of each electronic artifact. The function tracking system may generate new progress tracking templates for other electronic artifacts to be completed as functions associated with those electronic artifacts are completed. This mechanism may ensure efficient function management and reliable artifact processing. Once a function associated with an electronic artifact is completed, the function tracking system may update the function completion data structure to reflect the new status and dependencies.

In some embodiments, the function tracking system may generate a function completion data structure using user input. The function completion data structure may include a plurality of electronic artifacts (e.g., function descriptions, milestones, deliverables) and dependency data indicating relationships between these artifacts. The dependency data may ensure that functions are completed in the correct order as indicated by associated electronic artifacts, with dependent functions only initiated once their prerequisites are fulfilled. The function tracking system may generate a corresponding set of progress tracking templates for each electronic artifact, with each set including multiple templates indicating the completion of specific functions associated with a corresponding electronic artifact.

The function tracking system may then receive progress data associated with a first electronic artifact. The progress data may include parameters (e.g., completion values, time data, performance length, etc.) related to the completion of a function corresponding to the first electronic artifact. Based on this progress data, the function tracking system may determine the necessary parameters to update the first electronic artifact within the function completion data structure. This process ensures that the data structure accurately reflects the current status for the function completion data structure and the associated electronic artifacts.

The function tracking system may identify initiation-ready electronic artifacts based on the dependency data after or when updating the first electronic artifact. Initiation-ready electronic artifacts may include functions that may now be performed because their prerequisite tasks have been completed. The function tracking system may select a corresponding progress template for each initiation-ready electronic artifact based on the updated parameters. The selected templates may then be transmitted to the associated operators, which are assigned to perform the corresponding functions.

The function tracking system may generate new progress tracking templates for subsequent functions based on the completion of the current functions and the associated data within the electronic artifacts. For example, once a coding function is completed, the system may generate new templates for testing and deployment functions. This dynamic and adaptive approach may ensure that a job progresses smoothly and efficiently, with all dependencies and prerequisites being managed automatically by the function tracking system.

Based on the generation of new progress tracking templates, the function tracking system may transmit the templates to the associated operators. For example, each associated operator may receive assigned templates indicating the next set of functions to be completed. This mechanism may enhance the reliability and speed of function completion, ensuring that the job progresses without significant delays or bottlenecks. The use of electronic artifacts and dependency data may enable the function tracking system to leverage structured job management, further improving the efficiency of the electronic artifacts.

The function tracking system may also update the function completion data structure to reflect the new status and dependencies. In particular, the function tracking system may update the data structure when a function is completed, ensuring that the electronic artifact status is accurately reflected. By updating the data structure, the function tracking system may reduce the risk of errors and ensure that all functions are managed efficiently.

In some embodiments, the described mechanism may ensure that relevant progress data is preserved and utilized, while non-essential data is discarded to optimize storage and job management resources. Thus, the function tracking system may delete the non-essential progress data, ensuring that only the relevant progress data is available to provide insights into the efficiency and effectiveness of job execution, helping operators identify bottlenecks, inefficiencies, and areas for improvement.

The described methods and systems for tracking function completion may provide a solution for efficient and reliable artifact management. By dynamically evaluating function dependencies and strategically generating progress tracking templates, the function tracking system may ensure optimal use of available resources within the scope of a function execution plan. Furthermore, the function tracking system may maintain the efficiency and reliability of the function execution progression with the possibility of enhancing the speed and accuracy of function completion. The potential to update the function completion data structure further underscores the function tracking system's adaptability and effectiveness in meeting artifact constraints and ensuring successful task outcomes.

Various other aspects, features, and advantages of the system will be apparent through the detailed description and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative system for tracking function completion based on electronic artifacts, in accordance with one or more embodiments of this disclosure.

FIG. 2 illustrates an excerpt of a data structure storing representations of a plurality of electronic artifacts and their dependencies, in accordance with one or more embodiments of this disclosure.

FIG. 3 illustrates an excerpt of a data structure storing representations of progress data, in accordance with one or more embodiments of this disclosure.

FIG. 4 illustrates an excerpt of a data structure storing representations of progress data entries and their corresponding dependency parameters and function output parameters, in accordance with one or more embodiments of this disclosure.

FIG. 5 illustrates an excerpt of a data structure storing representations of initiation-ready electronic artifacts and their corresponding dependency parameters and template outputs, in accordance with one or more embodiments of this disclosure.

FIG. 6 illustrates a computing device, in accordance with one or more embodiments of this disclosure.

FIG. 7 is a flowchart of operations for tracking function completion using electronic artifacts, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

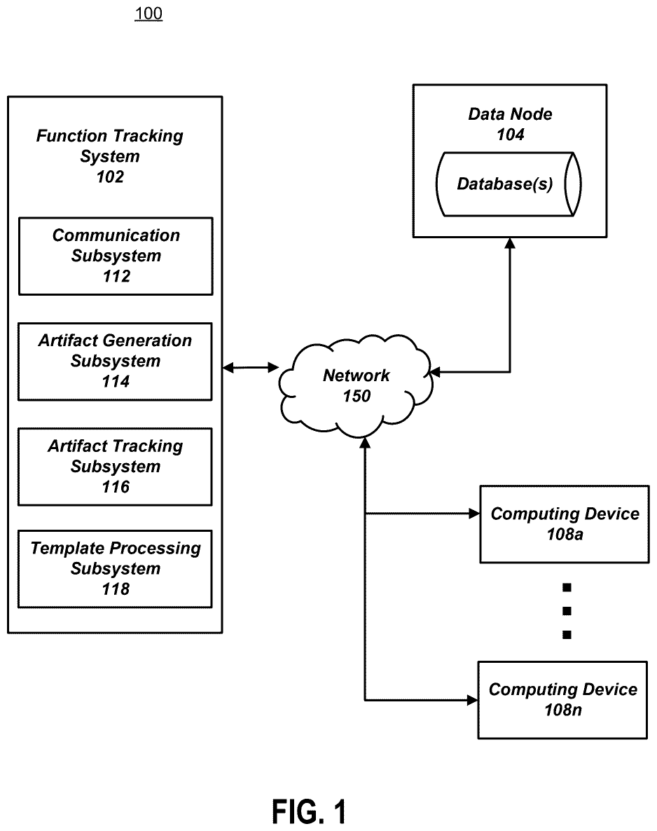

FIG. 1 is an example of environment 100 for tracking function completion based on electronic artifacts (e.g., a digital object that represents a specific function or milestone within a job). Environment 100 includes function tracking system 102, data node 104, and computing devices 108a-108n. Function tracking system 102 may also include communication subsystem 112, artifact generation subsystem 114, artifact tracking subsystem 116, and template processing subsystem 118. Function tracking system 102 may execute instructions for tracking function completion using electronic artifacts to address the need for systematic management and utilization of completion data in various job management fields such as software, banking, insurance, etc. Function tracking system 102 may include software, hardware, or a combination of the two. For example, function tracking system 102 may be hosted on a physical server or a virtual server that is running on a physical computer system. In some embodiments, function tracking system 102 may be configured on a user device (e.g., a laptop computer, a smartphone, a desktop computer, an electronic tablet, or another suitable user device).

Data node 104 may store various data, including data records, dependency parameters, tracking data, template data, artifact data, and/or other data. Data node 104 may include software, hardware, or a combination of the two. For example, data node 104 may be a physical server or a virtual server that is running on a physical computer system. In some embodiments, function tracking system 102 and data node 104 may reside on the same hardware and/or the same virtual server/computing device. Network 150 may be a local area network (LAN), a wide area network (WAN) (e.g., the Internet), or a combination of the two. Computing devices 108a-108n may be end-user computing devices (e.g., desktop computers, laptops, electronic tablets, smartphones, and/or other computing devices used by end users).

In addition to allocating cloud computing resources to applications/devices in the cloud, function tracking system 102 may be configured to receive one or more requests (e.g., data inputs) from one or more sources based on user inputs, algorithms, external systems, and internal processes. These requests may include, but are not limited to, progress updates, completion notifications, permission requests, and dependency updates. Function tracking system 102 may process (e.g., update) the one or more requests to maintain an accurate and up-to-date function completion data structure to track progress of the overall job. For example, function tracking system 102 may receive a progress update request from an operator (e.g., user, machine learning) indicating that a specific function associated with an electronic artifact has reached a certain milestone. This progress update may include function completion data dependent on the current status, start and end times, performance metrics (e.g., any issues encountered during the task), and other relevant dependency data confirming the completion. Upon receiving this request, the function tracking system 102 may generate the corresponding electronic artifact identifiers, template identifiers, progress entry, or progress tracking template for the artifact and/or subsequent artifacts. Also, the function tracking system 102 may update the function completion data structure to reflect the new status of the subsequent electronic artifacts and identify initiation-ready electronic artifacts based on the updated dependency data.

In some embodiments, function tracking system 102 may receive initial data for generating a function completion data structure. For example, the initial data may be data from the user indicating various project information for tracking the project. The information may include project tasks, milestones, task dependencies and/or other suitable data. In some embodiments, function tracking system 102 may perform the following operations to track function completion using electronic artifacts. Function tracking system 102 may receive one or more requests associated with a plurality of job management tasks (e.g., progress updates, completion notifications, permission requests). Each request may be a request to generate a function completion data structure (e.g., for a particular project). Function tracking system 102 may receive the requests using communication subsystem 112. Communication subsystem 112 may include software components, hardware components, or a combination of both. For example, communication subsystem 112 may include a network card (e.g., a wireless network card and/or a wired network card) that is associated with software to drive the card. In some embodiments, communication subsystem 112 may receive the requests from data node 104 or from another computing device. In some embodiments, communication subsystem 112 may receive the requests from one or more computing devices 108a-108n.

In some embodiments, the requests may be received after the function completion data structure has been generated. The requests may include progress updates, completion notifications, or permission requests related to the tracking of function completion using electronic artifacts. Function tracking system 102 may process each request and update the function completion data structure accordingly. For example, upon receiving a progress update request, function tracking system 102 may update the status of the corresponding electronic artifact and generate new progress tracking templates, if necessary. In some embodiments, function tracking system 102 may store each request and the corresponding updates. Different electronic artifacts (e.g., tasks) may send different types of requests for tracking various aspects of job progress. For example, a completion notification may include data confirming that a specific function associated with an electronic artifact has been completed, along with a timestamp indicating the completion time. These requests may be stored on data node 104 and processed by function tracking system 102 at particular times or intervals to ensure the function completion data structure is always up to date.

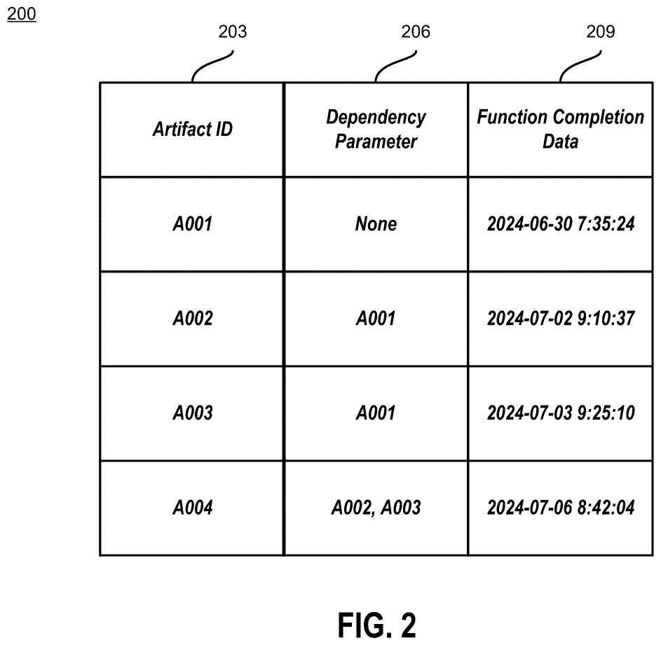

As discussed above, function tracking system 102 may generate a function completion data structure that includes the electronic artifacts and corresponding dependency data. Dependency data may indicate dependency relationships between one or more electronic artifacts within the plurality of electronic artifacts. For example, if initiation of functions associated with artifact A002 depends on completion of functions associated with artifact A001, artifact A002 will depend on artifact A001 (e.g., as shown in FIG. 2). Function tracking system 102 may use artifact generation subsystem 114 to perform this operation. Artifact generation subsystem 114 may include software components, hardware components, or a combination of both. For example, artifact generation subsystem 114 may include software instructions for generating and maintaining electronic artifacts. Thus, artifact generation subsystem 114 may generate a function completion data structure that includes a plurality of electronic artifacts and dependency data indicating relationships between these electronic artifacts. Thus, artifact generation subsystem 114 may generate electronic artifacts and the corresponding artifact identifiers based on user input and/or algorithms. In some embodiments, each electronic artifact may represent a specific function or milestone within a job, and the dependency data may ensure that electronic artifacts are completed in the correct order.

FIG. 2 illustrates an excerpt of a data structure 200 storing representations of a plurality of electronic artifacts and their dependencies (e.g., parameters, function completion data) from the data node 104. Fields 203 may store artifact identifiers for electronic artifacts. For example, an artifact identifier may be a unique identifier such as a number, an alphanumeric string, or another suitable identifier. These artifact identifiers may be used to track and manage the individual electronic artifacts within the overall project. In some embodiments, electronic artifacts may be identified as A001, A002, A003, and A004 (e.g., artifact identifiers). Electronic artifacts may represent distinct tasks (e.g., prerequisite jobs) that need to be completed.

Fields 206 may store the dependency parameter(s), which indicate the relationships between the electronic artifacts. The data in the dependency parameter(s) may ensure that electronic artifacts are completed in the correct order, as specified by function completion data structure. For example, the dependent electronic artifacts may be initiated once their prerequisite electronic artifact(s) are fulfilled. The electronic artifact A001 may not depend on any other electronic artifact to be initiated because A001 does not have any dependency parameters in corresponding field 206. Electronic artifacts A002, A003, and A004 may have dependency parameters and corresponding fields 206. For example, electronic artifact A002 and A003 both depend on the completion of A001 before their respective functions (e.g., tasks) can be initiated. Upon the completion of A001, function tracking system 102 updates the function completion data with the completion timestamp (e.g., 2024 Jun. 30 7:35:24) in field 209 for A001. Function tracking system 102 may then generate the next electronic artifacts identified as A002 and A003 with the corresponding dependency data. The update may ensure that the tasks associated with A002 and A003 can be initiated and tracked accordingly.

In order to track the progress of each electronic artifact, function tracking system 102 may use artifact tracking subsystem 116. Artifact tracking subsystem 116 may monitor the completion status and relevant functions and update parameters to the electronic artifacts. Artifact tracking subsystem 116 may include software, hardware, or a combination of both. For example, artifact tracking subsystem 116 may include software that may process function completion data using one or more processors as described below.

In some embodiments, a pending electronic artifact may have a more complex dependency structure that requires more than one prerequisite electronic artifact to be completed before the pending electronic artifact is available to be initiated. For example, the dependency parameter(s) in fields 206 for the electronic artifact A004 may indicate that both electronic artifacts A002 and A003 must be completed prior to initiating A004. Once function tracking system 102 tracks the completion data for A002 and A003 as complete, function tracking system 102 may update the function completion statuses of the prerequisite electronic artifacts. The update may ensure that the function (e.g., task) associated with A004 is initiated only after its prerequisite electronic artifacts have been completed.

In some embodiments, fields 209 may store function completion data, which records the completion timestamp and status of each electronic artifact via artifact tracking subsystem 116. For example, once electronic artifact A001 is completed (e.g., all the functions associated with electronic artifact A001 are completed), artifact tracking subsystem 116 may track A001's timestamp recorded in corresponding field 209. Artifact tracking subsystem 116 may update the corresponding field 209 to reflect A001's completion status to “complete.” Once A001's status is updated to “complete,” artifact tracking subsystem 116 may proceed to process the completion data. This process (e.g., updating completion status of artifact) may be repeated for each subsequent electronic artifact, ensuring that the data structure accurately reflects the current status of the function completion data structure (e.g., representing a project) until all electronic artifacts and their prerequisites have been completed.

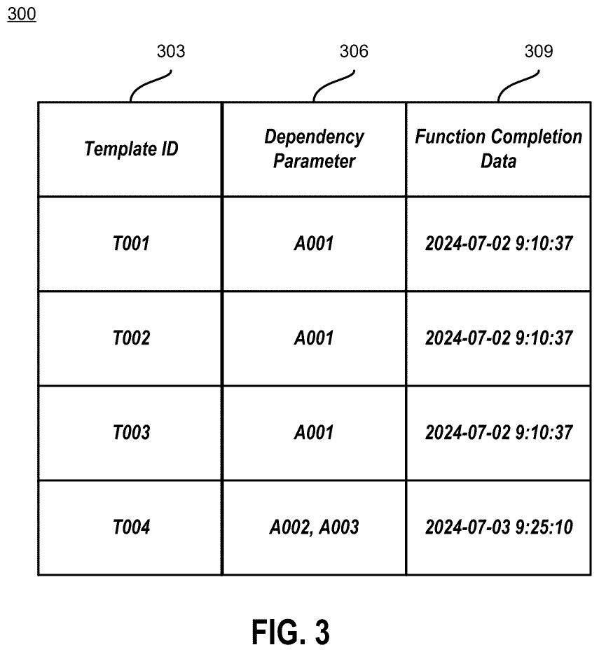

FIG. 3 illustrates an excerpt of a data structure 300 storing representations of a set of progress tracking templates and their dependencies (e.g., parameters, function completion data) from the data node 104. Fields 303 may store progress tracking templates that correspond to template identifiers for the function tracking system 102, for example, a unique identifier such as a number, an alphanumeric string, or another suitable identifier. These template identifiers may be used to track and manage the progress of individual tasks within the overall project. In some embodiments, the fields 303 templates may be identified as T001, T002, T003, and T004. The templates correspond to distinct electronic artifacts (e.g., A001, A002, A003, and A004) that have associated functions that need to be completed in sequential order as part of, for example, a project due to dependency parameters. The templates may be processed by template processing subsystem 118. Template processing subsystem 118 may generate and manage the progress tracking templates for each electronic artifact.

Fields 306 may store the dependency parameter(s), which indicate the relationships between the templates and their corresponding electronic artifacts. The data in the dependency parameter(s) may ensure that electronic artifacts are completed in the correct order, as specified by the user input before the template processing subsystem 118 generates a pending template. For example, the dependent templates from fields 303 may initiate once their prerequisite electronic artifact(s) are fulfilled. The templates T001, T002, and T003 correspond to electronic artifact A001 because A001 is the first electronic artifact (e.g., task) that must be completed per the user input. T001, T002, and T003 may help identify templates that were generated by the template processing subsystem 118 in the function tracking system 102. Therefore, the dependency parameter for T001, T002, and T003 in fields 306 states “A001,” indicating the dependency required to start and complete the task. The dependency parameter in fields 306 for the templates T001, T002, and T003 indicates that A001 must be completed first. T001, T002, and T003 all depend on the completion of A001 before their respective functions and/or tasks can be initiated. Upon the completion of A001, the function tracking system 102 may update the function completion data for A001 and the template processing subsystem 118 may generate the corresponding progress tracking template for T002 and T003. The update may ensure that the electronic artifact associated with T002 and T003 can be initiated and tracked accordingly.

In some embodiments, a pending template may have a more complex dependency structure that requires more than one prerequisite electronic artifact to be completed (e.g., the corresponding functions to be completed) before the pending template may be initiated. For example, the dependency parameter(s) in fields 306 for the template T004 in fields 303 may indicate that both electronic artifacts A002 and A003 must be completed before initiation. Once function tracking system 102 tracks the completion data for A002 and A003, function tracking system 102 may update the function completion statuses of the prerequisite electronic artifacts, and template processing subsystem 118 may generate the corresponding progress tracking template for T004. The update may ensure that the function/task associated with T004 may be initiated only after its prerequisite artifacts have been completed.

Fields 309 may store the function completion data, which may record the completion timestamp and status of each template. In some embodiments, fields 309 may store other information in addition or instead of timestamp and status data. The function completion data in fields 309 may indicate to the template processing subsystem 118 in the function tracking system 102 to generate progress tracking templates that correspond to a template identifier in fields 303. For example, once the electronic artifact A001 in fields 303 is completed, the function tracking system 102 tracks A001's timestamp from fields 309 that indicates when A001 was completed. Function tracking system 102 may update the fields 309 to reflect A001's completion status to “complete.” Once A001's status is updated to “complete”, the template processing subsystem 118 may generate progress tracking templates for T002 and T003. This process (e.g., updating completion status of template) is repeated for each subsequent template, ensuring that the data structure accurately reflects the current status of the project until all templates have been generated and their prerequisite electronic artifacts have been completed.

Fields 303 and fields 306 may include a template and electronic artifact identifier with fields 309 storing a timestamp corresponding to a time when a particular function completion data was received. For example, a timestamp may be a time when a progress update was submitted, which may be hours or days after the actual task was completed. Fields 309 may include function completion data. In the context of function tracking, function completion data may include task status, completion times, and/or other suitable data.

When the dependency data and/or requests are received, communication subsystem 112 may pass the dependency data, requests, or a pointer to the requests in memory to template processing subsystem 118. Template processing subsystem 118 may include software components, hardware components, or a combination of both. For example, template processing subsystem 118 may include software components that access one or more databases (e.g., on data node 104) to retrieve dependency data for generating progress tracking templates with template identifiers. Thus, template processing subsystem 118 may generate, for each electronic artifact, a corresponding set of progress tracking templates. Each set of progress tracking templates may include a plurality of progress tracking templates for each electronic artifact. Furthermore, each progress tracking template may indicate that a function associated with a corresponding electronic artifact has been completed.

Accordingly, template processing subsystem 118 may generate, based on a parameter or parameters from the dependency data associated with a first electronic artifact, a first template identifier for a first progress tracking template. For example, a first dependency data may be a request to initiate a particular task for a first electronic artifact. Accordingly, template processing subsystem 118 may generate a template identifier for a progress tracking template based on the parameters of the first dependency data of the first electronic artifact. In a project management example, template processing subsystem 118 may create a template identifier for a progress tracking template that indicates the steps required to complete a task based on the received data.

In some embodiments, template processing subsystem 118 may generate the template identifiers for all or some received dependency data before sending a notification to function tracking system 102 that template identifiers have been generated. However, in some embodiments, template processing subsystem 118 may send an indication to function tracking system 102 that a particular template now has an associated template identifier. Template processing subsystem 118 may include software components, hardware components, or a combination of both. For example, template processing subsystem 118 may include software components that access one or more memory locations for processing requests as they relate to the dependency data. Function tracking system 102 may include software components, hardware components, or a combination of both, and may be responsible for managing the progress tracking templates generated by template processing subsystem 118.

In some embodiments, template processing subsystem 118 may generate progress tracking templates for the electronic artifacts so that function completion progress may be tracked. In particular, template processing subsystem 118 may generate for each electronic artifact a corresponding set of progress tracking templates. Each set of progress tracking templates may include one or more progress tracking templates for each electronic artifact. Furthermore, each progress tracking template may indicate that a function associated with a corresponding electronic artifact has been completed.

In some embodiments, function tracking system 102 may use the following operations for generating, for each electronic artifact, the corresponding set of progress tracking templates. In particular, artifact generation subsystem 114 may retrieve a data structure associated with a second artifact of the plurality of electronic artifacts. The data structure may include a plurality of artifact parameters. For example, one or more artifacts within the function completion data structure may be tasks within a project. Each task may have a multitude of parameters such as task details, task description, etc. Thus, each artifact (e.g., each task) may have multiple associated parameters. Thus, artifact generation subsystem 114 may determine, based on the plurality of parameters, a plurality of data sources for retrieving one or more parameters of the plurality of parameters. Based on the determination, artifact generation subsystem 114 may generate the plurality of progress tracking templates based on different values retrieved from the plurality of data sources for each parameter of the plurality of parameters. For example, a progress tracking template may include prompts for task completion, completion description, and or other parameters. In some embodiments, different data sources may be different databases that may store the information required. In some embodiments, the different data sources may include files, web pages, and/or other suitable data sources.

In some embodiments, artifact generation subsystem 114 may use various data sources for parameter retrieval. In particular, artifact generation subsystem 114 may retrieve a data structure associated with a second artifact of the plurality of electronic artifacts. The data structure may include a plurality of artifact parameters. For example, one or more artifacts within the function completion data structure may be tasks within a project. Each task may have a multitude of parameters such as task details, task description, etc. Thus, each artifact (e.g., each task) may have multiple associated parameters.

In some embodiments, one or more parameter values may be retrieved from one or more different data sources (e.g., different databases). Thus, artifact generation subsystem 114 may determine, based on the plurality of parameters, a plurality of data sources for retrieving one or more parameters of the plurality of parameters. For example, each parameter may be stored with a corresponding data source that enables artifact generation subsystem 114 to retrieve the parameter value to be used when generating progress tracking templates for the corresponding electronic artifact. As discussed above, one or more parameters may be retrieved from databases and/or files. Artifact generation subsystem 114 may then generate the plurality of progress tracking templates based on different values retrieved from the plurality of data sources. For example, one or more artifacts within the function completion data structure may be tasks within a project. Each task may have a multitude of parameters such as task details, task description, etc. Thus, each artifact (e.g., each task) may have multiple associated parameters. Each parameter may have a corresponding parameter value that may be retrieved from a data source (e.g., a database located on data node 104).

When the function completion data structure and the corresponding electronic templates are generated, artifact tracking subsystem 116 may perform tracking functions. In particular, artifact tracking subsystem 116 may receive progress data associated with a first electronic artifact. The progress data may include progress parameters associated with a first function corresponding to the first electronic artifact. For example, when a particular function is completed, a user or an electronic system may fill in a corresponding template and submit the filled-out template to artifact tracking subsystem 116. Artifact tracking subsystem 116 may receive the progress data and store that progress data (e.g., within a database).

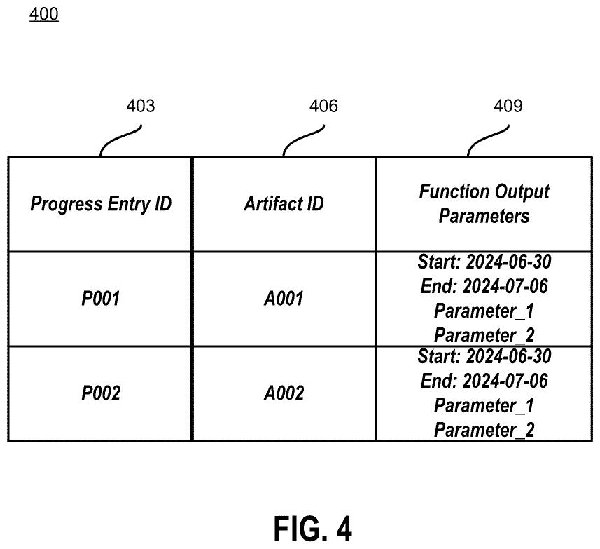

FIG. 4 illustrates an excerpt of a data structure 400 storing representations of progress data. Field 403 may store progress data entries for the function tracking system 102 that may be identified, for example, as a number, an alphanumeric string, or another suitable identifier. For example, the progress data entry in field 403 may be identified as P001. P001 may represent the progress data associated with a first electronic artifact, which may include progress parameters related to a specific function corresponding to the first electronic artifact. Field 406 may store the dependency parameters, which indicate the relationships between the progress data entry and the corresponding electronic artifacts. The dependency parameters may ensure that the progress data is accurately associated with the relevant electronic artifacts. For example, the dependency parameter in field 406 corresponding to the progress data entry P001 may be A001. The parameter may indicate that the progress data entry P001 is related to the progress of the electronic artifact A001 (e.g., completion status/time of different functions). Fields 409 may store the function output parameters, which are the progress parameters that indicate the start and completion of the electronic artifacts. The function output parameters in field 409 also include the completion status (e.g., complete, in progress, not started) from the progress data of the overall job. For example, the function output parameters for the progress data entry P001 may include the start time (e.g., 2024 Jun. 30 7:35:24) of the first electronic artifact A001, the completion time (e.g., 2024 Jul. 6 8:42:04) of the first electronic artifact A001, and the overall completion status of the job (e.g., Parameter_1, Parameter_2). These progress parameters from field 409 may be used to update the function completion data structure within the function tracking system 102. Thus, in some embodiments, function tracking system 102 may receive progress data (e.g., progress parameters with a first function) associated with a first electronic artifact. The progress data may include progress parameters associated with a first function corresponding to the first electronic artifact.

Furthermore, in some embodiments, function tracking system 102 may determine, based on the progress data, a plurality of parameters for updating the first electronic artifact within the function completion data structure. For example, as template processing subsystem 118 iterates through progress data entries, template processing subsystem 118 may identify one or more dependency parameters that match the progress data entry (e.g., the progress data entry has dependencies on A001). For example, template processing subsystem 118 may update the function completion data structure to reflect the start and completion times of the electronic artifact A001 based on the progress data entry P001. Thus, the progress data may indicate completion of the first function associated with the first electronic artifact.

In some embodiments, template processing subsystem 118 may perform the following operations when determining the parameters for updating the function completion data structure. Template processing subsystem 118 may retrieve corresponding dependency data for a plurality of electronic artifacts. The plurality of electronic artifacts may be associated with one or more progress data entries. For example, template processing subsystem 118 may retrieve (e.g., from data node 104) a data structure that stores dependency information (e.g., as shown in FIG. 4). Once the dependency information is retrieved, template processing subsystem 118 may, for example, use field 406 for matching the progress data entry with the dependency parameters.

Furthermore, template processing subsystem 118 may compare the progress data associated with the first electronic artifact with the corresponding dependency data of each electronic artifact of the plurality of electronic artifacts. For example, template processing subsystem 118 may retrieve progress data from a progress update that corresponds to a particular electronic artifact. In addition, template processing subsystem 118 may retrieve dependency information (e.g., from field 406) and iterate through each dependency parameter to compare the progress data with the dependency data associated with each electronic artifact. For example, template processing subsystem 118 may determine whether the progress data indicates that the electronic artifact has started or completed.

Template processing subsystem 118 may then determine, based on comparing the progress data associated with the first electronic artifact with the corresponding dependency data of each electronic artifact of the plurality of electronic artifacts, the function output parameters for updating the function completion data structure. For example, as template processing subsystem 118 iterates through each dependency parameter, template processing subsystem 118 may identify matching progress data. In some embodiments, when template processing subsystem 118 identifies matching progress data, template processing subsystem 118 may stop iterating through other dependency parameters. However, in some embodiments, template processing subsystem 118 may continue the iteration process and may match multiple dependency parameters to the progress data. For example, multiple electronic artifacts may have overlapping dependencies. Accordingly, template processing subsystem 118 may match multiple dependency parameters. In a project management example, a particular dependency parameter may be a prerequisite task (e.g., A001 must be completed before A002). Another dependency parameter may be a concurrent task (e.g., A003 and A004 can be completed simultaneously). Thus, if the progress data indicates that A001 is completed, that progress data may match both dependency parameters.

As discussed above, in some embodiments, template processing subsystem 118 may determine that the progress data matches multiple dependency parameters. Accordingly, template processing subsystem 118 may perform the following operations when multiple dependency parameters are matched. Template processing subsystem 118 may determine, based on the progress data matching different dependency parameters, different function output parameters for updating the function completion data structure. For example, if the first function output parameter is a start time and the second function output parameter is a completion time, template processing subsystem 118 may combine those parameters to arrive at the final function output parameter. Once the function output parameter is determined, template processing subsystem 118 may update the function completion data structure with the determined function output parameter.

When the function output parameter has been determined, template processing subsystem 118 may update, based on the progress data and the function output parameter, the function completion data structure. The updated function completion data structure may then reflect the current status of the project. For example, template processing subsystem 118 may retrieve the progress data determined based on the parameters of the progress data entry and apply the function output parameter to update the function completion data structure. In some embodiments, the progress data may correspond to a status update that was assigned to a task (e.g., based on the progress made) and that status update may be used to update the function completion data structure. Thus, the function output parameter may be a status update determined based on progress data and/or other criteria.

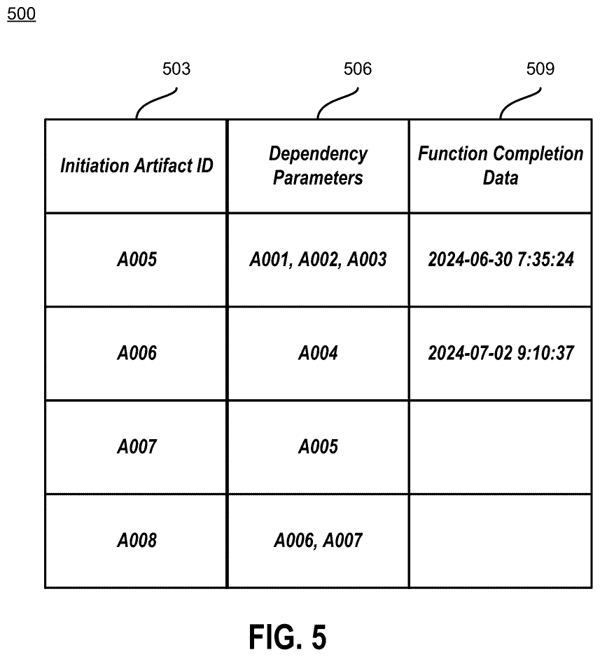

FIG. 5 illustrates an excerpt of a data structure 500 storing representations of initiation-ready electronic artifacts with corresponding dependency parameters and function completion data. Fields 503 may store initiation-ready electronic artifacts for the function tracking system 102, for example, unique identifiers such as numbers, alphanumeric strings, or other suitable identifiers. In some embodiments, the initiation-ready electronic artifacts may be identified as A005, A006, A007, and A008. The electronic artifacts in fields 503 may be ready to be initiated based on the completion of their respective dependency parameters.

Fields 506 may store the dependency parameters (e.g., electronic artifact identifiers), which indicate the relationships (e.g., parent and child artifacts) between the initiation-ready electronic artifacts and their corresponding prerequisite electronic artifacts. The dependency parameters may ensure that the initiation-ready electronic artifacts are accurately associated with the relevant completed artifacts. For example, the dependency parameters in fields 506 correspond to the initiation-ready electronic artifacts from fields 503. A001, A002, and A003 correspond to initiation-ready electronic artifact A005. A004 corresponds to initiation-ready electronic artifact A006. A005 corresponds to initiation-ready electronic artifact A007. A006 and A007 both correspond to initiation-ready electronic artifact A008. These parameters indicate that the initiation-ready electronic artifacts can only be initiated once their respective dependencies are completed. For example, that may depend on completion of functions for artifacts.

Fields 509 may store the function completion data for the initiation-ready electronic artifacts. In field 509, the fields that show the completion timestamp (e.g., 2024 Jun. 30 7:35:24) help the function tracking system 102 determine which electronic artifacts are completed and which electronic artifacts are not completed. In particular, the progress tracking templates may be generated for the initiation-ready electronic artifacts once the respective dependency parameters are completed. The progress tracking templates may provide a structured way to capture and monitor the progress of the initiation-ready electronic artifacts. For example, the progress tracking templates generated by function tracking system 102 may be identified as T005, T006, T007, and T008 (not shown). T005 corresponds to A005; T006 corresponds to A006; T007 corresponds to A007; and T008 corresponds to A008. The progress tracking templates may be used to track the progress of the initiation-ready electronic artifacts and ensure that the electronic artifacts are completed in the correct order.

In some embodiments, the process may begin with function tracking system 102 updating the first electronic artifact based on the received progress data. Once the first electronic artifact is updated, function tracking system 102 may identify, based on the dependency data within the function completion data structure, one or more initiation-ready electronic artifacts of the plurality of electronic artifacts. For example, function tracking system 102 may determine that A005, A006, A007, and A008 are initiation ready based on the completion of their respective dependencies (e.g., A001, A002, A003 for A005; A004 for A006; A005 for A007; and A006 and A007 for A008).

Furthermore, function tracking system 102 may select, for each electronic artifact of the one or more initiation-ready electronic artifacts, a corresponding progress tracking template from the corresponding set of progress tracking templates. The selection may be based on the updated parameters within the function completion data structure. For example, function tracking system 102 may select T005 for A005, T006 for A006, T007 for A007, and T008 for A008. These templates are generated to track the progress of the initiation-ready electronic artifacts and ensure that they are completed in the correct order.

Once the corresponding progress tracking templates are selected, function tracking system 102 transmits each corresponding progress template to be completed by an associated operator. The transmission may ensure that the initiation-ready electronic artifacts are initiated and tracked according to the progress tracking templates. Moreover, in response to transmitting each corresponding progress template to be completed by the associated operator, function tracking system 102 may receive completion data associated with one or more progress templates. In response to the completion data, function tracking system 102 may generate a state associated with the function completion data structure. For example, function tracking system 102 may transmit progress tracking templates to one or more devices associated with users who have been selected to complete those templates. Those users may complete the templates using their corresponding user devices and may then transmit filled-out templates (e.g., including completion data) back to function tracking system 102. Function tracking system 102 may analyze the completed templates to determine which artifact or artifacts may be marked as having all or some functions completed.

Furthermore, function tracking system 102 may identify a second artifact associated with the completion data. Function tracking system 102 may update the second artifact based on the completion data. Function tracking system 102 may generate the state associated with the function completion data structure based on updating the second artifact. For example, function tracking system 102 may transmit T005 to the operator responsible for A005, T006 to the operator responsible for A006, T007 to the operator responsible for A007, and T008 to the operator responsible for A008. This process ensures that the initiation-ready electronic artifacts are completed in the correct order and that their progress is accurately tracked and managed.

### Computing Environment

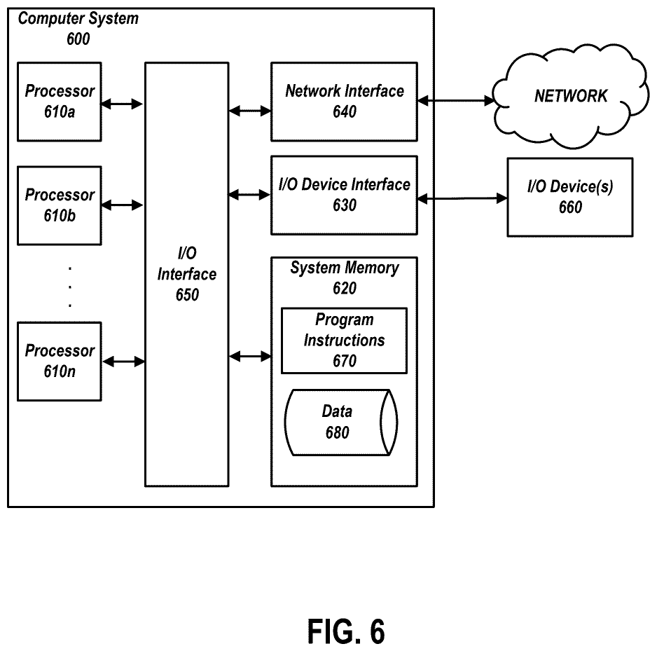

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a) or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a LAN, a WAN, a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM memory), volatile memory (e.g., random access memory (RAM), static RAM (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600 or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated or may operate as a stand-alone system. In addition, the functionality provided by the illustrated components may, in some embodiments, be combined in fewer components or distributed in additional components. Similarly, in some embodiments, the functionality of some of the illustrated components may not be provided, or other additional functionality may be available.

### Operation Flow

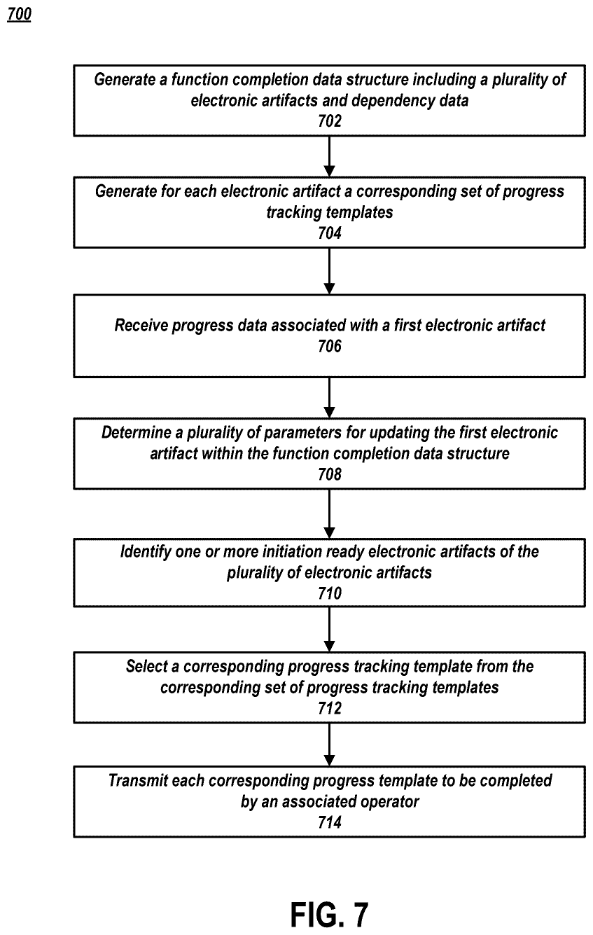

FIG. 7 is a flowchart 700 of operations for tracking function completion using electronic artifacts. The operations of FIG. 7 may use components described in relation to FIG. 6. In some embodiments, function tracking system 102 may include one or more components of computer system 600.

At 702, function tracking system 102 generates a function completion data structure including a plurality of electronic artifacts and dependency data for the plurality of electronic artifacts. Function tracking system 102 may generate the function completion data structure based on user input, which includes the dependency relationships between the electronic artifacts. For example, function tracking system 102 may generate the electronic artifacts from data node 104 and/or from one or more computing devices 108a-108n. Function tracking system 102 may generate the electronic artifacts over network 150 using network interface 640.

At 704, function tracking system 102 may generate for each electronic artifact a corresponding set of progress tracking templates. Each set of progress tracking templates comprises a plurality of progress tracking templates for each electronic artifact, and each progress tracking template indicates that a function associated with a corresponding electronic artifact has been completed. For example, function tracking system 102 may retrieve a data structure associated with a second artifact of the plurality of electronic artifacts. The data structure comprises a plurality of artifact parameters. Based on the plurality of parameters, function tracking system 102 may determine one or more values for each parameter and generate the plurality of progress tracking templates based on different values for each parameter. Additionally, function tracking system 102 may determine a plurality of data sources for retrieving one or more parameters of the plurality of parameters and generate the plurality of progress tracking templates based on different values retrieved from the plurality of data sources. Furthermore, function tracking system 102 may generate the progress tracking templates from data node 104 and/or from one or more computing devices 108a-108n. Function tracking system 102 may generate the progress tracking templates over network 150 using network interface 640.

At 706, function tracking system 102 may receive progress data associated with a first electronic artifact. The progress data comprises progress parameters associated with a first function corresponding to the first electronic artifact. For example, function tracking system 102 may use one or more processors 610a-610n to perform the operation and store the results in system memory 620.

At 708, function tracking system 102 may determine a plurality of parameters for updating the first electronic artifact within the function completion data structure via the progress data. The progress data indicates completion of the first function associated with the first electronic artifact. For example, function tracking system 102 may use one or more processors 610a-610n to perform the operation and store the results in system memory 620.

At 710, function tracking system 102 may identify one or more initiation-ready electronic artifacts of the plurality of electronic artifacts by means of the dependency data within the function completion data structure. For example, function tracking system 102 may use one or more processors 610a-610n to perform the operation. Function tracking system 102 may identify one or more initiation-ready electronic artifacts from a dependency data in memory or from a database (e.g., a database stored on data node 104).

At 712, function tracking system 102 may select a corresponding progress tracking template from the corresponding set of progress tracking templates for each initiation-ready electronic artifact. Each selection of the electronic artifact of the one or more initiation-ready electronic artifacts is based on updated parameters within the function completion data structure. For example, function tracking system 102 may use one or more processors 610a-610n to perform the operation and store the results in system memory 620.

At 714, function tracking system 102 may transmit each corresponding progress template to be completed by an associated operator. This transmission may ensure that the initiation-ready electronic artifacts are initiated and tracked according to the progress tracking templates. After transmitting each corresponding progress template to be completed by the associated operator, function tracking system 102 may receive completion data associated with one or more progress templates and, based on the completion data, generate a state associated with the function completion data structure. In response to receiving the completion data, function tracking system 102 may identify a second artifact associated with the completion data, update the second artifact based on the completion data, and generate the state associated with the function completion data structure based on updating the second artifact. Furthermore, function tracking system 102 may delete one or more progress tracking templates that have not been selected. For example, function tracking system 102 may use one or more processors 610a-610n to perform the operation and store the results in system memory 620. Function tracking system 102 may transmit each corresponding progress template using one or more processors 610a-610n.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A system for tracking function completion using electronic artifacts, the system comprising:
one or more processors; and
one or more memories configured to store instructions that when executed by the one or more processors perform operations comprising:
generating, based on user input, a function completion data structure comprising a plurality of electronic artifacts and dependency data for the plurality of electronic artifacts, the dependency data indicating dependency relationships between one or more electronic artifacts within the plurality of electronic artifacts;
generating for each electronic artifact a corresponding set of progress tracking templates, wherein each set of progress tracking templates comprises a plurality of progress tracking templates for each electronic artifact, and wherein each progress tracking template indicates that a function associated with a corresponding electronic artifact has been completed;
receiving progress data associated with a first electronic artifact, wherein the progress data comprises progress parameters associated with a first function corresponding to the first electronic artifact;
determining, based on the progress data, a plurality of values for a plurality of parameters for updating the first electronic artifact within the function completion data structure, wherein the progress data indicates completion of the first function associated with the first electronic artifact;
subsequent to updating the first electronic artifact, identifying, based on the dependency data within the function completion data structure, one or more initiation-ready electronic artifacts of the plurality of electronic artifacts that are dependent, for initiation, upon the plurality of parameters being updated with the plurality of values for the first electronic artifact within the function completion data structure;
selecting, for each electronic artifact of the one or more initiation-ready electronic artifacts and based on updated parameters within the function completion data structure, a corresponding progress tracking template from the corresponding set of progress tracking templates;
transmitting each corresponding progress template to be completed by an associated operator;
identifying, from a subset of the plurality of progress tracking templates that have not been selected, one or more non-essential progress tracking templates;
automatically deleting the one or more non-essential progress tracking templates from the subset of the plurality of progress tracking templates that have not been selected;
updating, without requiring operator input, the function completion data structure to reflect a new status and the dependency relationships in response to the automatic deleting of the one or more non-essential progress tracking templates, wherein the updating ensures the function completion data structure accurately reflects a current status of the plurality of electronic artifacts; and
storing the updated function completion data structure in the one or more memories.

2. The system of claim 1, wherein the instructions further cause the one or more processors to delete one or more other progress tracking templates that have not been selected.

3. The system of claim 1, wherein the instructions for generating for each electronic artifact the corresponding set of progress tracking templates further cause the one or more processors to perform operations comprising:
retrieving a data structure associated with a second artifact of the plurality of electronic artifacts, wherein the data structure comprises a plurality of artifact parameters;
determining, based on the plurality of parameters, one or more values for each parameter of the plurality of parameters; and
generating the plurality of progress tracking templates based on different values for each parameter of the plurality of parameters.

4. The system of claim 1, wherein the instructions for generating for each electronic artifact the corresponding set of progress tracking templates further cause the one or more processors to perform operations comprising:
retrieving a data structure associated with a second artifact of the plurality of electronic artifacts, wherein the data structure comprises a plurality of artifact parameters;
determining, based on the plurality of parameters, a plurality of data sources for retrieving one or more parameters of the plurality of parameters; and
generating the plurality of progress tracking templates based on different values retrieved from the plurality of data sources.

5. The system of claim 1, wherein the instructions further cause the one or more processors to perform operations comprising:
based on transmitting each corresponding progress template to be completed by the associated operator, receiving completion data associated with one or more progress templates; and
generating, based on the completion data, a state associated with the function completion data structure.

6. The system of claim 5, wherein the instructions further cause the one or more processors to perform operations comprising:
in response to receiving the completion data, identifying a second artifact associated with the completion data;
updating the second artifact based on the completion data; and
generating the state associated with the function completion data structure based on updating the second artifact.

7. The system of claim 1, wherein the instructions further cause the one or more processors to perform operations comprising:
based on transmitting each corresponding progress template to be completed by the associated operator, receiving completion data associated with one or more progress templates, wherein the completion data comprises an indication of a permission requirement;
identifying an operator for granting permission; and
transmitting a permission request to the operator, wherein the permission request is generated based on the permission requirement with the completion data.

8. A method for tracking function completion using electronic artifacts, the method comprising:
generating, based on user input, a function completion data structure comprising a plurality of electronic artifacts and dependency data for the plurality of electronic artifacts;
generating for each electronic artifact a corresponding set of progress tracking templates, wherein each set of progress tracking templates comprises a plurality of progress tracking templates for each electronic artifact;
receiving progress data associated with a first electronic artifact, wherein the progress data comprises progress parameters associated with a first function corresponding to the first electronic artifact;
determining, based on the progress data, a plurality of values for a plurality of parameters for updating the first electronic artifact within the function completion data structure, wherein the progress data indicates completion of the first function associated with the first electronic artifact;
identifying, based on the dependency data within the function completion data structure, one or more initiation-ready electronic artifacts of the plurality of electronic artifacts that are dependent upon the plurality of parameters being updated with the plurality of values for the first electronic artifact within the function completion data structure;
selecting, for each electronic artifact of the one or more initiation-ready electronic artifacts and based on updated parameters within the function completion data structure, a corresponding progress tracking template from the corresponding set of progress tracking templates;
transmitting each corresponding progress template to be completed by an associated operator;
identifying, from a subset of the plurality of progress tracking templates that have not been selected, one or more non-essential progress tracking templates; automatically deleting the one or more non-essential progress tracking templates from the subset of the plurality of progress tracking templates that have not been selected;
updating, without requiring operator input, the function completion data structure to reflect a new status and the dependency relationships in response to the automatic deleting of the one or more non-essential progress tracking templates, wherein the updating ensures the function completion data structure accurately reflects a current status of the plurality of electronic artifacts; and
storing the updated function completion data structure in the one or more memories.

9. The method of claim 8, wherein the dependency data indicates dependency relationships between one or more electronic artifacts within the plurality of electronic artifacts.

10. The method of claim 8, wherein each progress tracking template indicates that a function associated with a corresponding electronic artifact has been completed.

11. The method of claim 8, wherein generating for each electronic artifact the corresponding set of progress tracking templates further comprises:
retrieving a data structure associated with a second artifact of the plurality of electronic artifacts, wherein the data structure comprises a plurality of artifact parameters;
determining, based on the plurality of parameters, one or more values for each parameter of the plurality of parameters; and
generating the plurality of progress tracking templates based on different values for each parameter of the plurality of parameters.

12. The method of claim 8, wherein generating for each electronic artifact the corresponding set of progress tracking templates further comprises:
retrieving a data structure associated with a second artifact of the plurality of electronic artifacts, wherein the data structure comprises a plurality of artifact parameters;
determining, based on the plurality of parameters, a plurality of data sources for retrieving one or more parameters of the plurality of parameters; and
generating the plurality of progress tracking templates based on different values retrieved from the plurality of data sources.

13. The method of claim 8, further comprising:
based on transmitting each corresponding progress template to be completed by the associated operator, receiving completion data associated with one or more progress templates; and
generating, based on the completion data, a state associated with the function completion data structure.

14. The method of claim 13, further comprising:
in response to receiving the completion data, identifying a second artifact associated with the completion data;
updating the second artifact based on the completion data; and
generating the state associated with the function completion data structure based on updating the second artifact.

15. The method of claim 8, further comprising:
based on transmitting each corresponding progress template to be completed by the associated operator, receiving completion data associated with one or more progress templates, wherein the completion data comprises an indication of a permission requirement;
identifying an operator for granting permission; and
transmitting a permission request to the operator, wherein the permission request is generated based on the permission requirement with the completion data.

16. One or more non-transitory, computer-readable media storing instructions thereon, wherein the instructions cause one or more processors to perform operations comprising:
generating, based on user input, a function completion data structure comprising a plurality of electronic artifacts and dependency data for the plurality of electronic artifacts;
generating for each electronic artifact a corresponding set of progress tracking templates, wherein each set of progress tracking templates comprises a plurality of progress tracking templates for each electronic artifact;
receiving progress data associated with a first electronic artifact, wherein the progress data comprises progress parameters associated with a first function corresponding to the first electronic artifact;
determining, based on the progress data, a plurality of parameters for updating the first electronic artifact within the function completion data structure, wherein the progress data indicates completion of the first function associated with the first electronic artifact;
identifying, based on the dependency data within the function completion data structure, one or more initiation-ready electronic artifacts of the plurality of electronic artifacts that are dependent upon the plurality of parameters being updated for the first electronic artifact within the function completion data structure;
selecting, for each electronic artifact of the one or more initiation-ready electronic artifacts and based on updated parameters within the function completion data structure, a corresponding progress tracking template from the corresponding set of progress tracking templates;
transmitting each corresponding progress template to be completed by an associated operator;
automatically deleting, from a subset of the plurality of progress tracking templates that have not been selected, one or more non-essential progress tracking templates;
updating, without requiring operator input, the function completion data structure to reflect a new status and the dependency relationships in response to the automatic deleting of the one or more non-essential progress tracking templates, wherein the updating ensures the function completion data structure accurately reflects a current status of the plurality of electronic artifacts; and
storing the updated function completion data structure in the one or more memories.

17. The one or more non-transitory, computer-readable media of claim 16, wherein the instructions further cause the one or more processors to perform operations comprising:
retrieving a data structure associated with a second artifact of the plurality of electronic artifacts, wherein the data structure comprises a plurality of artifact parameters;
determining, based on the plurality of parameters, a plurality of data sources for retrieving one or more parameters of the plurality of parameters; and
generating the plurality of progress tracking templates based on different values retrieved from the plurality of data sources.

18. The one or more non-transitory, computer-readable media of claim 16, wherein the instructions further cause the one or more processors to perform operations comprising:
based on transmitting each corresponding progress template to be completed by the associated operator, receiving completion data associated with one or more progress templates; and
generating, based on the completion data, a state associated with the function completion data structure.

19. The one or more non-transitory, computer-readable media of claim 18, wherein the instructions further cause the one or more processors to perform operations comprising:
in response to receiving the completion data, identifying a second artifact associated with the completion data;
updating the second artifact based on the completion data; and
generating the state associated with the function completion data structure based on updating the second artifact.

20. The one or more non-transitory, computer-readable media of claim 16, wherein the instructions further cause the one or more processors to perform operations comprising:
based on transmitting each corresponding progress template to be completed by the associated operator, receiving completion data associated with one or more progress templates, wherein the completion data comprises an indication of a permission requirement;
identifying an operator for granting permission; and
transmitting a permission request to the operator, wherein the permission request is generated based on the permission requirement with the completion data.
